(19) United States
(12) Patent Application Publication
(10) Pub. No.: US 2010/0196235 A1
(43) Pub. Date: Aug. 5, 2010

(54) PROCESS FOR SEQUESTRATION OF CARBON DIOXIDE BY MINERAL CARBONATION

(76) Inventors: Jacobus Johannes Cornelis Geerlings, Amsterdam (NL); Evert Wesker, Amsterdam (NL)

Correspondence Address: SHELL OIL COMPANY, P O BOX 2463, HOUSTON, TX, 772522463, US

(21) Appl. No.: 12/600,695

(22) PCT Filed: May 16, 2008
(86) PCT No.: PCT/EP08/56027

§ 371 Date: Apr. 1, 2010

(30) Foreign Application Priority Data
May 21, 2007 (EP) 07108540.1

(51) Int. Cl. C01B 31/20

(52) U.S. Cl. 423/232

(57) ABSTRACT

The invention provides a process for sequestration of carbon dioxide by mineral carbonation comprising the following steps: (a) converting a magnesium or calcium sheet silicate hydroxide into a magnesium or calcium ortho- or chain silicate by bringing the silicate hydroxide in direct or indirect heat-exchange contact with hot flue gas to obtain the silicate, silica, water and cooled flue gas; (b) contacting the silicate obtained in step (a) with carbon dioxide to convert the silicate into magnesium or calcium carbonate and silica.

### FIELD OF THE INVENTION

The present invention provides a process for the sequestration of carbon dioxide by mineral carbonation.

### BACKGROUND OF THE INVENTION

It is known that carbon dioxide may be sequestered by mineral carbonation. In nature, stable carbonate minerals and silica are formed by a reaction of carbon dioxide with natural silicate minerals:

(Mg,Ca)ₓSi_{y}O_{x+2y}+xCO₂ [symbol] x(Mg,Ca)CO₃+ySiO₂

The reaction in nature, however, proceeds at very low reaction rates. The feasibility of such a reaction in process plants has been studied. These studies mainly aim at increasing the reaction rate.

In a 2007 publication of the US National Energy Technology Laboratory, Environ. Sci. & Technol. (Gerdemann et al.), for example, is disclosed the reaction of finely ground serpentine (Mg₃Si₂O₅(OH)₄) or olivine (Mg₂SiO₄) in a solution of supercritical carbon dioxide and water to form magnesium carbonate. Under conditions of high temperature and pressure, 81% conversion of olivine has been achieved in several hours and a 92% conversion of pre-heated serpentine in less than an hour.

In WO02/085788, for example, is disclosed a process for mineral carbonation of carbon dioxide wherein particles of silicates selected from the group of ortho-, di-, ring, and chain silicates, are dispersed in an aqueous electrolyte solution and reacted with carbon dioxide.

It is known that orthosilicates or chain silicates can be relatively easy reacted with carbon dioxide to form carbonates and can thus suitably be used for carbon dioxide sequestration. Examples of magnesium or calcium orthosilicates suitable for mineral carbonation are olivine, in particular forsterite, and monticellite. Examples of suitable chain silicates are minerals of the pyroxene group, in particular enstatite or wollastonite. The more abundantly available magnesium or calcium silicate hydroxide minerals, for example serpentine and talc, are sheet silicates and are therefore more difficult to convert into carbonates. Very high activation energy is needed to convert these sheet silicate hydroxides into their corresponding ortho- or chain silicates.

### SUMMARY OF THE INVENTION

It has now been found that abundantly available sheet silicate hydroxides such as serpentine or talc can be advantageously converted into their corresponding silicates by using heat available in hot flue gas. The thus-formed silicate is an ortho- or chain silicate and can be carbonated in a mineral carbonation step.

Accordingly, the present invention provides a process for sequestration of carbon dioxide by mineral carbonation comprising the following steps:

(a) converting a magnesium or calcium sheet silicate hydroxide into a magnesium or calcium ortho- or chain silicate by bringing the silicate hydroxide in direct or indirect heat-exchange contact with hot flue gas to obtain the silicate, silica, water and cooled flue gas;

(b) contacting the silicate obtained in step (a) with carbon dioxide to convert the silicate into magnesium or calcium carbonate and silica.

An advantage of the process of the invention is that hot flue gas can be effectively cooled whilst the desired conversion of sheet silicate hydroxides into the corresponding ortho- or chain silicates is accomplished.

Another advantage is that hot flue gas is typically available at locations where carbon dioxide is produced, especially at power generation facilities.

A further advantage is that by cooling the hot flue gas the need for flue gas cooling facilities is reduced.

### DETAILED DESCRIPTION OF THE INVENTION

In the process according to the invention a magnesium or calcium sheet silicate hydroxide mineral is first converted in conversion step (a) into a magnesium or calcium ortho- or chain silicate mineral by bringing the silicate hydroxide in heat-exchange contact with hot flue gas. The thus-formed silicate is then contacted with carbon dioxide to convert the silicate into magnesium or calcium carbonate and silica in mineral carbonation step (b).

Silicates are composed of orthosilicate monomers, i.e. the orthosilicate ion SiO₄⁴⁻ which has a tetrahedral structure. Orthosilicate monomers form oligomers by means of O—Si—O bonds at the polygon corners. The Q^{s} notation refers to the connectivity of the silicon atoms. The value of superscript s defines the number of nearest neighbour silicon atoms to a given Si. Orthosilicates, also referred to as nesosilicates, are silicates which are composed of distinct orthosilicate tetrathedra that are not bonded to each other by means of O—Si—O bonds (Q⁰ structure). Chain silicates, also referred to as inosilicates, might be single chain (SiO₃²⁻ as unit structure, i.e. a (Q²)ₙ structure) or double chain silicates ((Q³Q²)ₙ structure). Sheet silicates, also referred to as phyllosilicates, have a sheet structure (Q³)ₙ.

Above a certain temperature, sheet silicate hydroxide is converted into its corresponding ortho- or chain silicate, silica and water. Serpentine for example is converted at a temperature of at least 500° C. into olivine. Talc is converted at a temperature of at least 800° C. into enstatite.

Preferably, conversion step (a) is carried out by directly contacting the hot flue gas with a fluidised bed of silicate hydroxide particles. Direct heat transfer from hot gas to solid mineral particles in a fluidised bed is very efficient.

The temperature of the fluidised bed may dependent on several conditions including the temperature of the mineral particles supplied to the fluidised bed, the temperature of hot flue gas and the temperature of the cooled flue gas. In order to maintain the temperature in the fluidised bed, the hot flue gas must provide at least part, preferably all, of the energy necessary to heat the mineral particles to the fluidised bed temperature. This requires adapting the hot flue gas-to-mineral ratio and/or the temperature of the hot flue gas to respond to the incoming temperature of the mineral particles and the desired fluidized bed temperature. By controlling the continuous supply and discharge of flue gas and mineral particles to and from the fluidised bed, a constant bed temperature can be maintained.

The mineral particles may be preheated prior to entering the fluidised bed. Preferably, the mineral particles are preheated to a temperature close to the temperature at which the sheet silicate hydroxide is converted. The mineral particles may for instance be pre-heated via heat exchange with other process streams, for example the hot converted mineral and/or with step (b) the mineral carbonation. Preferably, the mineral particles are preheated to a temperature of at least 300° C., more preferably, at least 450° C., even more preferably in the range of from 500 to 650° C.

In order to attain conversion of the sheet silicate hydroxide, the hot flue gas should have a temperature of at least 500° C. for serpentine conversion and a temperature of at least 800° C. for talc conversion. Preferably, the hot flue gas has a temperature in the range of from 500 to 1250° C., more preferably of from 600 to 1250° C., in order to attain the temperature in the fluidised bed required for the conversion. If a flue gas is available having a temperature above 1250° C., the temperature of the flue gas may be reduced to obtain the hot flue gas that is contacted with the silicate hydroxide in step (a). Preferably, the flue gas is a flue gas having a temperature in the range of from 1300 to 1900° C. Reducing the temperature of the flue gas has the additional advantage that there are less temperature constraints on the design of the reactor.

It will be appreciated that the temperature of a flue gas having a temperature below 1250° C. may also be reduced if desired.

If the flue gas is above 1250° C., the flue gas is preferably quenched to lower the temperature of the flue gas. More preferably, the flue gas is quenched by introducing for instance air, water or any other suitable quenching medium into the hot flue gas. Preferably, the flue gas is quenched with a quenching medium that is available in abundance. Another preferred way of quenching is by recycling part of the cooled flue gas and admixing this recycled cooled flue gas with the hot flue gas before contacting the silicate hydroxide.

It will be appreciated that the temperature of the cooled flue gas will depend on, inter alia, the hot flue gas-to-mineral ratio and the temperature of the hot flue gas. Typically, the cooled flue gas has a temperature of at least 450° C., preferably a temperature in the range of from 550 to 800° C. The cooled flue gas may be further cooled by bringing it in heat exchange contact with silicate hydroxide particles to be supplied to conversion step (a), thereby pre-heating the silicate hydroxide to be converted. An advantage of quenching the hot flue gas with recycled cooled flue gas is that no energy is lost, rather it is only divided over a larger volume of gas the quench.

If the silicate hydroxide is serpentine, conversion step (a), i.e. the conversion of serpentine into olivine, is preferably carried out at a temperature in the range of from 500 to 800° C., more preferably of from 600 to 700° C. Below 500° C., there is no significant conversion of serpentine into olivine. Above 800° C., a crystalline form of olivine is formed that is more difficult to convert into magnesium carbonate than the amorphous olivine formed at a temperature below 800° C. It will be appreciated that crystallization of olivine can already occur to an extent at temperatures lower than 800° C., however, it should be realised that this requires prolonged residence times at such temperatures.

Therefore, serpentine conversion step (a) is preferably carried out by directly contacting hot flue gas with a fluidised bed of serpentine particles, wherein the fluidised bed has a temperature in the range of from 500 to 800° C., preferably of from 600 to 700° C.

If the silicate hydroxide is talc, the fluidised bed preferably has a temperature in the range of from 800 to 1000° C.

The magnesium silicate hydroxide particles in the fluidised bed preferably have an average diameter in the range of from 10 to 300 μm, more preferably of from 30 to 150 μm. Reference herein to average diameter is to the volume medium diameter D(v, 0.5), meaning that 50 volume % of the particles have an equivalent spherical diameter that is smaller than the average diameter and 50 volume % of the particles have an equivalent spherical diameter that is greater than the average diameter. The equivalent spherical diameter is the diameter calculated from volume determinations, e.g. by laser diffraction measurements.

In step (a) of the process according to the invention, silicate hydroxide particles of the desired size may be supplied to the fluidised bed. Alternatively, larger particles, i.e. up to a few mm, may be supplied to the fluidised bed. As a result of the expansion of the steam formed during the conversion reaction in step (a), the larger particles will fragment into the desired smaller particles.

Reference herein to magnesium or calcium silicate hydroxide is to silicate hydroxides comprising magnesium, calcium or both. Part of the magnesium or calcium may be replaced by other metals, for example iron, aluminium or manganese. Any magnesium or calcium silicate hydroxide belonging to the group of sheet silicates may be suitably used in the process according to the invention. Examples of suitable silicate hydroxides are serpentine, talc and sepiolite. Serpentine and talc are preferred silicate hydroxides. Serpentine is particularly preferred.

Serpentine is a general name applied to several members of a polymorphic group of minerals having essentially the same molecular formula, i.e. (Mg, Fe)₃Si₂O₅(OH)₄ or Mg₃Si₂O₅(OH)₄, but different morphologic structures. In step (a) of the process according to the invention, serpentine is converted into olivine. The olivine obtained in step (a) is a magnesium silicate having the molecular formula (Mg,Fe)₂SiO₄ or Mg₂SiO₄, depending on the iron content of the reactant serpentine. Serpentine with a high magnesium content, i.e. serpentine that has or deviates little from the composition Mg₃Si₂O₅(OH)₄, is preferred since the resulting olivine has the composition Mg₂SiO₄ (forsterite) and can sequester more carbon dioxide than olivine with a substantial amount of magnesium replaced by iron.

Talc is a mineral with chemical formula Mg₃Si₄O₁₀(OH)₂. In step (a) of the process according to the invention, talc is converted into enstatite, i.e. MgSiO₃.

In mineral carbonation step (b), the silicate formed in step (a) is contacted with carbon dioxide to convert the silicate into magnesium or calcium carbonate and silica.

In step (b), the carbon dioxide is typically contacted with an aqueous slurry of silicate particles. In order to achieve a high reaction rate, it is preferred that the carbon dioxide concentration is high, which can be achieved by applying an elevated carbon dioxide pressure. Suitable carbon dioxide pressures are in the range of from 0.05 to 100 bar (absolute), preferably in the range of from 0.1 to 50 bar (absolute). The total process pressure is preferably in the range of from 1 to 150 bar (absolute), more preferably of from 1 to 75 bar (absolute).

A suitable operating temperature for mineral carbonation step (b) is in the range of from 20 to 250° C., preferably of from 100 to 200° C.

Reference herein to flue gas is to an off gas of a combustion reaction, typically the combustion of a hydrocarbonaceous feedstock, Flue gas typically comprises a gaseous mixture comprising carbon dioxide, water and optionally nitrogen. The hydrocarbonaceous feedstock may for example be natural gas or other light hydrocarbon streams, liquid hydrocarbons, biomass, or coal. Optionally, the hydrocarbonaceous feedstock may be syngas. Syngas generally refers to a gaseous mixture comprising carbon monoxide and hydrogen, optionally also comprising carbon dioxide and steam. Syngas is usually obtained by partial oxidation or gasification of a hydrocarbonaceous feedstock. The hydrocarbonaceous feedstock may for example be natural gas or other light hydrocarbon streams, liquid hydrocarbons, biomass, or coal.

Preferably, natural gas or syngas is used as the hydrocarbonaceous combustion feedstock. These feedstocks burn cleanly and therefore produce a hot flue gas, which does not comprise ashes or other solids. Such ashes and other solids may contaminate the product obtained in step (a).

The water obtained in step (a) may be used for instance to provide an aqueous slurry in step (b) of the process according to the invention. Alternatively, the water obtained in step (a) may be recovered from the cooled flue gas and used for other applications, such as part of the feed to a steam methane reformer, water-gas shift reactor, or be used in the generation of power.

The process according to the invention is particularly suitable to sequester the carbon dioxide in flue gas obtained from gas turbines. The process according to the invention may advantageously be combined with power generation in a gas turbine. If the gas turbine is fed with natural gas or syngas, a carbon dioxide comprising hot flue gas is obtained. At least part of the hot flue gas may then be used to convert a magnesium or calcium sheet silicate hydroxide into a magnesium or calcium ortho- or chain silicate according to step (a) of the process according to the invention. At least part of the carbon dioxide containing cooled flue gas may then be contacted with the silicate in mineral carbonation step (b) to sequester at least part of the carbon dioxide.

### EXAMPLE

The process according to the invention will be further illustrated by the following non-limiting example (1).

In a process 100 ton/h of carbon dioxide is captured and separated. 210 ton/h of serpentine is required to convert this carbon dioxide completely into magnesium carbonate. The serpentine is preheated to a temperature of 640° C. by heat exchange with cooled flue gas of 650° C. To provide the heat for activation 3.6 ton/h of natural gas (LHV=37.9 MJ/m³) is combusted with 66 ton/h of air to provide 69.6 ton/h of flue gas, having a temperature of 1900° C. To lower the temperature of the flue gas, the flue gas is subsequently quenched with further 54 ton/h of air to yield a hot flue gas with a temperature of 1200° C. Contacting this hot flue gas with the pre-heated serpentine in the fluidised bed will yield a bed temperature of 650° C.

Combustion of the natural gas will result in the production of 9.8 ton/h additional carbon dioxide. Therefore the net carbon dioxide removal efficiency is 91%.

1. A process for sequestration of carbon dioxide by mineral carbonation comprising the following steps:
(a) converting a magnesium or calcium sheet silicate hydroxide into a magnesium or calcium ortho- or chain silicate by bringing the silicate hydroxide in direct or indirect heat-exchange contact with hot flue gas to obtain the silicate, silica, water and cooled flue gas;
(b) contacting the silicate obtained in step (a) with carbon dioxide to convert the silicate into magnesium or calcium carbonate and silica.

2. A process according to claim 1, wherein the silicate hydroxide is serpentine and the silicate is olivine.

3. A process according to claim 1, wherein the silicate hydroxide is talc and the silicate is enstatite.

4. A process according to claim 1, wherein the hot flue gas has a temperature in the range of from 500 to 1250° C.

5. A process according to claim 1, wherein the cooled flue gas has a temperature of at least 450° C.

6. A process according to claim 1, wherein a flue gas having a temperature above 1250° C. is quenched to obtain the hot flue gas.

7. A process according to claim 6, wherein the flue gas is quenched by admixing the flue gas with part of the cooled flue gas.

8. A process according to claim 1, wherein step (a) is carried out by directly contacting hot flue gas with a fluidised bed of silicate hydroxide particles.

9. A process according to claim 8, wherein the fluidised bed has a temperature in the range of from 500 to 800° C. wherein the silicate hydroxide is serpentine and the silicate is olivine.

10. A process according to claim 8, wherein the fluidised bed has a temperature in the range of from 800 to 1000° C. wherein the silicate hydroxide is talc and the silicate is enstatite.

11. A process according to claim 8, wherein the silicate hydroxide particles have an average diameter in the range of from 10 to 300 μm.

12. A process according to claim 1, wherein the cooled flue gas is further cooled in heat-exchange contact with silicate hydroxide that is to be supplied to step (a).

13. A process according to claim 1, wherein cooled flue gas comprises carbon dioxide and at least part of the cooled flue gas is contacted with the silicate in mineral carbonation step (b) to sequester at least part of the carbon dioxide.

14. (canceled)

15. A process according to claim 2, wherein the hot flue gas has a temperature in the range of from 500 to 1250° C.

16. A process according to claim 3, wherein the hot flue gas has a temperature in the range of from 500 to 1250° C.

17. A process according to claim 1, wherein the hot flue gas has a temperature in the range of from 600 to 1250° C.

18. A process according to claim 2, wherein the hot flue gas has a temperature in the range of from 600 to 1250° C.

19. A process according to claim 3, wherein the hot flue gas has a temperature in the range of from 600 to 1250° C.

20. A process according to claim 1, wherein the cooled flue gas has a temperature in the range of from 550 to 800° C.

21. A process according to claim 2, wherein the cooled flue gas has a temperature in the range of from 550 to 800° C.
